(19) United States
(12) Patent Application Publication
(10) Pub. No.: US 2011/0018801 A1
(43) Pub. Date: Jan. 27, 2011

(54) Visual Input/Output Device with Light Shelter

(75) Inventors: Yi-Hua WANG, Tainan (TW); Yu-Lun LO, Tainan (TW)

Correspondence Address: STOUT, UXA, BUYAN & MULLINS LLP, 4 VENTURE, SUITE 300, IRVINE, CA, 92618, US

(73) Assignee: HIMAX TECHNOLOGIES LIMITED, Tainan (TW)

(21) Appl. No.: 12/510,236

(22) Filed: Jul. 27, 2009

(51) Int. Cl. G09G 5/08; H04N 5/335; G09G 3/36

(52) U.S. Cl. 345/158; 348/273; 345/87; 348/E05.091

(57) ABSTRACT

A visual input/output device with a light shield is disclosed. The device includes an active area for performing visual input/output tasks, and a non-active area surrounding the active area in the peripheral area of the device. The light shield is formed in the non-active area for substantially preventing unwanted light from interfering with the active area. The light shield is formed on a same layer as a color filter in the active area, and the light shield is made of black pigment or carbon.

### BACKGROUND OF THE INVENTION

1. Field of the Invention

The present invention generally relates to visual input/output devices, and more particularly to a visual input/output device with a light shield.

2. Description of the Prior Art

Optical devices, such as visual input/output devices that input or output visual information, are widely used in modern electronic systems. The visual input device, such as a semiconductor based image sensor, converts images of incoming visible light into electronic signals. Complementary metal-oxide-semiconductor (CMOS) image sensors (or CISs) are popularly used, for example, in cameras or camcorders. The visual output device, such as a flat panel display, is used for presentation of visual information. Liquid crystal displays (LCDs) are popular components widely applied in modern electronic devices. Another popular display uses liquid crystal on silicon (LCOS), which is a reflective technology capable of producing a higher resolution image at a lower cost than the LCD and which has been developed as the optical engine for micro-projection and micro-display systems.

The visual input device or visual output device usually has a rectangular shape, the inner area of which is the active area (AA) for performing visual input/output and the peripheral area of which is the non-active area (NAA). For the CMOS image sensor, the inner area is the sensor area with the peripheral area surrounding the sensor area being the non-sensor area. For the LCOS display, the inner area is the display area with the peripheral area surrounding the display area being the non-display area.

For conventional visual input/output devices, the NAA is either concealed or not concealed. Even when the NAA is concealed, the added concealing construction still cannot satisfactorily prevent unwanted light from interfering with the AA. Taking the conventional CMOS image sensor as an example, a construction made of material of blue color filter (CF-B) is sometimes formed along the peripheral area or the non-sensor area. The material of the blue color filter, however, cannot satisfactorily block or absorb incident light leaking onto the sensor area as noise, thereby reducing image signal quality in the sensor area. Taking the conventional LCOS display as another example, the light either coming from outside or reflecting from an underlying metal (or circuit) layer commonly causes interference as scattered light, thereby reducing the quality of the image display.

For the reason that conventional visual input/output devices cannot effectively prevent unwanted light from interfering with the AA, a need has arisen to propose a novel scheme for substantially resolving the interference problem.

### SUMMARY OF THE INVENTION

In view of the foregoing, it is an object of the present invention to provide a light shield in a visual input/output device capable of satisfactorily preventing unwanted light from interfering with the active area (AA), to thereby increase one or more of image sensing and display quality.

According to one embodiment of the present invention, a complementary metal-oxide-semiconductor (CMOS) image sensor includes photodiodes formed on a semiconductor substrate, and a color filter in a sensor area formed over and aligned with the photodiodes. A light shield is formed in the non-sensor area for substantially preventing unwanted light from interfering with the sensor area. The light shield is formed on a same layer as the color filter, and the light shield is made of black pigment or carbon.

According to another embodiment of the present invention, a liquid crystal on silicon (LCOS) display includes a metal layer formed on a semiconductor substrate, and a color filter, located in a display area, is formed over the metal layer. A light shield is formed in the non-display area for substantially preventing unwanted light from interfering with the display area. The light shield is formed on a same layer as the color filter, and the light shield is made of black pigment or carbon.

### BRIEF DESCRIPTION OF THE DRAWINGS

FIG. 1A shows a plan view of a complementary metal-oxide-semiconductor (CMOS) image sensor according to one embodiment of the present invention;

FIG. 1B shows a cross-sectional view of the FIG. 1A CMOS image sensor along section line 1B-1B′;

FIG. 2A shows a plan view of a liquid crystal on silicon (LCOS) display according to another embodiment of the present invention; and

FIG. 2B shows a cross-sectional view of the FIG. 2A LCOS display along section line 2B-2B′.

### DETAILED DESCRIPTION OF THE INVENTION

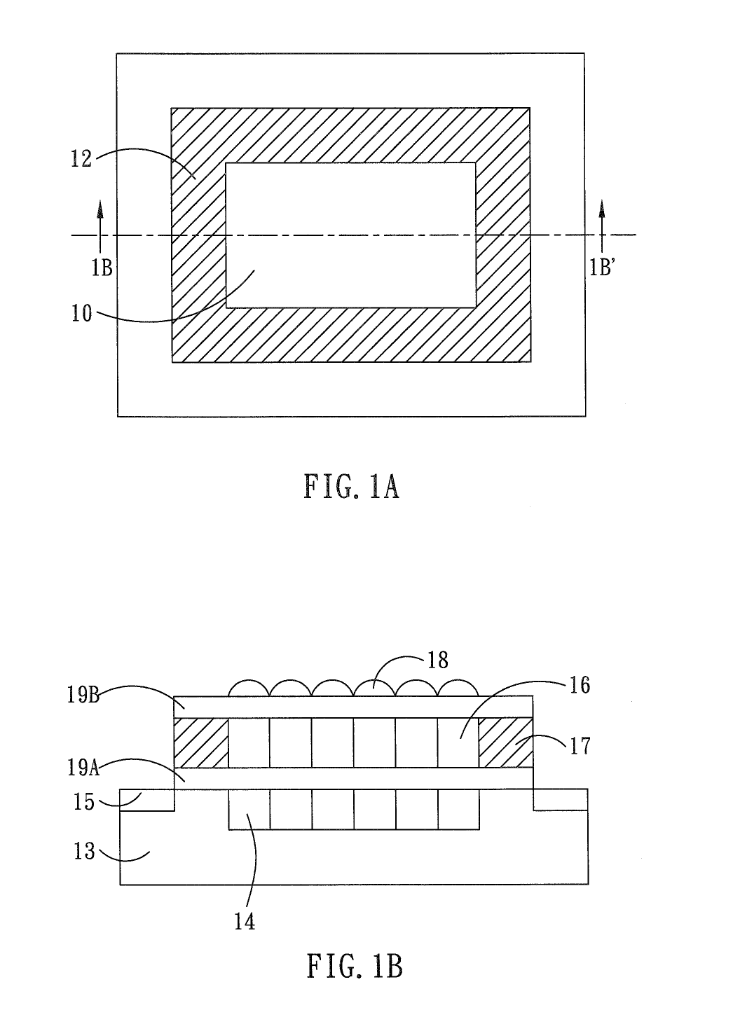

FIG. 1A shows a plan view of a complementary metal-oxide-semiconductor (CMOS) image sensor (or CIS) according to one embodiment of the present invention. FIG. 1B shows a cross-sectional view of the FIG. 1A CMOS image sensor along section line 1B-1B′. While the CMOS image sensor is illustrated in this embodiment, it is appreciated by those skilled in the pertinent art that the present invention may be well adapted to other visual input devices.

According to the plan view (FIG. 1A), the CMOS image sensor has, but is not necessarily limited to, a rectangular shape. The inner (rectangular) area of the CMOS image sensor is the active area (AA) 10 for performing visual input task (the image sensing in this case), and is usually known as the sensor area. The area surrounding the sensor area 10 in the peripheral area of the CMOS image sensor is the non-active area (NAA) 12, and is usually known as the non-sensor area. In the embodiment, the edge of the non-sensor area 12 is distanced from the edge of the entire CMOS image sensor. The non-sensor area 12 in the embodiment has a ring or loop shape. However, the non-sensor area 12 may, in other embodiments, extend outwardly until meeting the edge of the entire CMOS image sensor.

Referring to FIG. 1B, photodiodes 14 and peripheral circuits 15 are formed on a semiconductor substrate 13. Red/green/blue color filter (CF-RGB) 16 is formed over and aligned with the photodiodes 14. In the embodiment, a light shelter or shield 17 is formed in the same layer (e.g., a filter layer) as the color filter 16 or on the same layer (e.g., a planar layer 19A) as the color filter 16, and is located in the non-sensor area 12. The light shield 17 is capable of substantially preventing unwanted light from interfering with the sensor area 10. Specifically, the light shield 17 is capable of performing or accomplishing one or more of blocking and absorbing incident light, thereby preventing light from leaking into the sensor area 10. The light shield 17 may be made of or may comprise, but is not necessarily limited to, one or more of black pigment (e.g., alternatively, but not interchangeably, a pigment that is about black) and carbon. For instance, the light shield 17 may have a color of black and/or may comprise or consist essentially of one or more of black pigment and carbon. Micro-lens layer (ML-layer) 18 is formed over the color filter 16. For the purpose of making the surface of the CMOS image sensor even, one or more planar or smooth layers are formed on either surface of the color filter 16. In the embodiment, the planar layer (P-layer) 19A is formed between the substrate 13 and the color filter 16, and a smooth layer (S-layer) 19B is formed between the color filter 16 and the micro-lens layer 18.

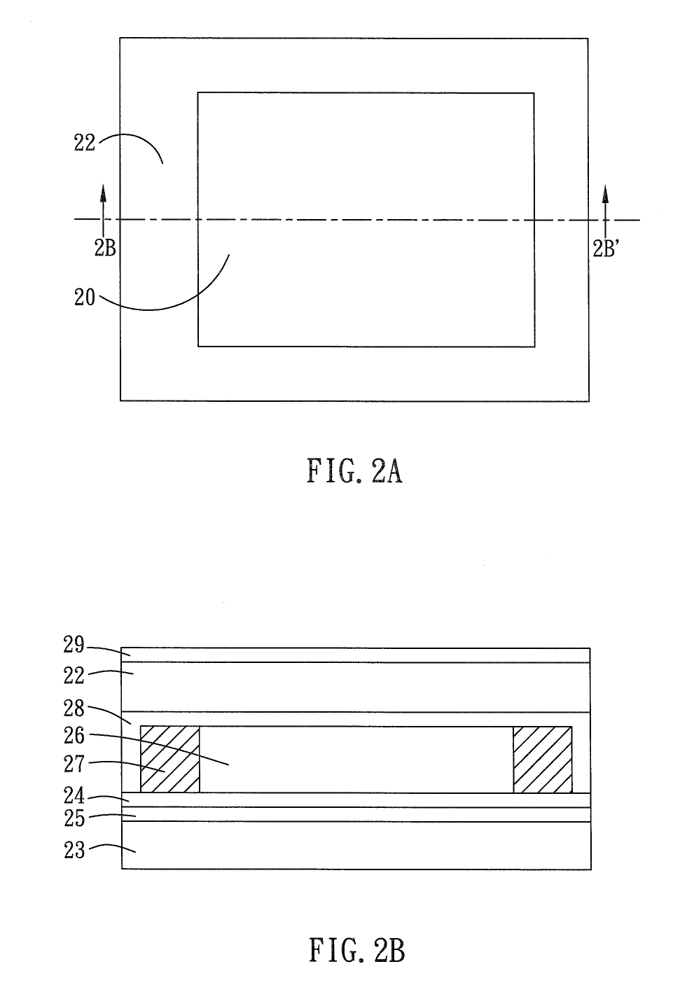

FIG. 2A shows a plan view of a liquid crystal on silicon (LCOS) display according to another embodiment of the present invention. FIG. 2B shows a cross-sectional view of the FIG. 2A LCOS display along section line 2B-2B′. While the LCOS display is illustrated in this embodiment, it is appreciated by those skilled in the pertinent art that the present invention may be well adapted to other visual output devices.

According to the plan view (FIG. 2A), the LCOS display has, but is not necessarily limited to, a rectangular shape. The inner (rectangular) area of the LCOS display is the AA 20 for performing visual output task (the image display in this case) and is usually known as the display area. The area surrounding the display area 20 in the peripheral area of the LCOS display is the NA area 22 and is usually known as the non-display area. In the embodiment, the non-display area 22 extends outwardly until approximately meeting the edge of the entire LCOS display. However, the non-display area 22 may, in other embodiments, have a ring or loop shape whereby the edge of the non-display area 22 is distanced from the edge of the entire LCOS display.

Referring to FIG. 2B, a metal (e.g., aluminum) layer 25 is formed on a semiconductor substrate 23. Red/green/blue color filter (CF-RGB) and/or even white color filter (CF-W) 26 is formed over the metal layer 25. In the embodiment, a light shelter or shield 27 is formed in or on the same layer (e.g., a filter layer or passivation 24 layer) as the color filter 26, and is located in the non-display area 22. The light shield 27 is capable of substantially preventing unwanted light from interfering with the display area 20. Specifically, the light shield 27 is capable of preventing light from entering into the display area 20 or reflecting from the underlying metal layer 25 as scattered light. The light shield 27 may be made of or may comprise, but is not necessarily limited to, one or more of black pigment and carbon. According to certain embodiments, it may be black or substantially (e.g., about) black, of a color so dark as to resemble the color black to the human eye (e.g., 80% black, 90% black, 95% black, or 98% black), and/or may comprise or consist essentially of one or more of black pigment and carbon to block or absorb visible light. According to certain embodiments, a key concept for the construction of the light shield as described herein is that it comprises a color dark enough and/or a material having a characteristic to enable the light shield to operate as an effectuate blocker and/or absorber of light (e.g., visible light). In one implementation, at least a portion of the light shield is about black. The passivation layer 24 may be further formed between the color filter 26 and the metal layer 25. An overcoat 28 covers the color filter 26 and the light shield 27. Liquid layer 22 is placed on the overcoat 28, followed by a glass 29 which is laid on the liquid layer 22.

Although specific embodiments have been illustrated and described, it will be appreciated by those skilled in the art that various modifications may be made without departing from the scope of the present invention, which is intended to be limited solely by the appended claims.

What is claimed is:

1. A visual input/output device, comprising:
an active area configured to perform a visual input/output task;
a non-active area surrounding the active area in a peripheral area of the visual input/output device; and
a light shield formed in the non-active area to substantially prevent unwanted light from interfering with the active area;
wherein the light shield is formed on a same layer as a color filter in the active area, and the light shield is made of one or more of black pigment and carbon.

2. The visual input/output device of claim 1, wherein the light shield is constructed to perform one or more of blocking and absorbing the unwanted light.

3. The visual input/output device of claim 1, wherein the light shield is about black.

4. The visual input/output device of claim 1, wherein the light shield comprises carbon.

5. The visual input/output device of claim 1, wherein the light shield consists essentially of carbon.

6. A complementary metal-oxide-semiconductor (CMOS) image sensor, comprising:
a semiconductor substrate;
a plurality of photodiodes formed on the semiconductor substrate;
a color filter formed over and aligned with the photodiodes, the color filter being located in a sensor area of the image sensor; and
a light shield formed in a non-sensor area of the image sensor and configured substantially to prevent unwanted light from interfering with the sensor area;
wherein the light shield is formed on a same layer as the color filter, and the light shield comprises one or more of black pigment and carbon.

7. The CMOS image sensor of claim 6, wherein the light shield is structured to accomplish one or more of blocking and absorbing incident light, thereby preventing the incident light from leaking into the sensor area.

8. The CMOS image sensor of claim 6, further comprising a micro-lens layer formed over the color filter.

9. The CMOS image sensor of claim 6, further comprising one or more planar layers formed on either surface of the color filter.

10. The CMOS image sensor of claim 6, wherein the light shield is made of black pigment.

11. The CMOS image sensor of claim 6, wherein the light shield is made of carbon.

12. The CMOS image sensor of claim 6, wherein the light shield consists essentially of carbon.

13. A liquid crystal on silicon (LCOS) display, comprising:
a semiconductor substrate;
a metal layer formed on the semiconductor substrate;
a color filter formed in a layer over the metal layer, the color filter being located in a display area; and
a light shield formed in a non-display area of a construction to substantially prevent unwanted light from interfering with the display area;
wherein the light shield is formed on a same layer as the color filter, and the light shield is made of one or more of black pigment and carbon.

14. The LCOS display of claim 13, wherein the light shield prevents light from entering into the display area or reflecting from the metal layer as scattered light.

15. The LCOS display of claim 13, further comprising a passivation layer formed between the color filter and the metal layer.

16. The LCOS display of claim 13, further comprising an overcoat covering the color filter and the light shield.

17. The LCOS display of claim 16, further comprising a liquid layer placed on the overcoat, and a glass laid on the liquid layer.

18. The LCOS display of claim 13, wherein the light shield consists essentially of black pigment.

19. The LCOS display of claim 13, wherein at least a portion of the light shield is about black.

20. The LCOS display of claim 13, wherein the light shield consists essentially of carbon.
